(19) United States
(12) Patent Application Publication
(10) Pub. No.: US 2004/0243757 A1
(43) Pub. Date: Dec. 2, 2004

(54) Connecting PCI buses

(76) Inventors: Brett Douglas Oliver, Tampa, FL (US); Jeremy Ramos, Tampa, FL (US); Thomas Edward Brown, Pinellas Park, FL (US)

Correspondence Address: Honeywell International Inc., Law Dept. AB2, PO Box 2245, Morristown, NJ, 07962-9806, US

(21) Appl. No.: 10/447,658

(22) Filed: May 29, 2003

(51) Int. Cl. G06F 13/36

(52) U.S. Cl. 710/314

(57) ABSTRACT

The secondary sides of PCI bridges are connected by inverting the normal bridge sense that defines a bridge's transparency window so that memory accessible on the secondary side is implied, as opposed to being implied on the primary side.

### BACKGROUND

This invention relates to techniques for connecting PCI buses using PCI bridges.

The PCI to PCI bridge standard says that two bridges that are connected together by a common secondary interface and have different primary busses are an “unusual configuration”.

A PCI to PCI bridge is a device that forwards transactions between two different PCI busses, connected to its primary and secondary sides, as illustrated in FIG. 1. The connection is accomplished through the use of a transparency memory 11 window defined by the bridge control logic. During, initial configuration of the PCI bus, a local master control (M in FIG. 4), i.e. a processor, on the primary side defines the bridge window to the secondary side and the other bus. A local PCI bus 9 connects the master with one or more targets T. Two registers in the PCI bridge configuration space, the memory base register and memory limit register define the window in terms of lower addresses for the transparency window 11 and upper addresses for the local window 12. The addresses are considered “transactions”. Transactions that are not captured by the transparency window 11 are by default captured by the window 12. These are transactions on the primary of side of the bus.

Bridges can also be connected together to form larger bus networks in a hierarchy, as shown in FIG. 2. This connection is always defined to be from the secondary side of an upstream bridge to the primary side of the downstream bridge. Connecting multiple bridges together by their secondary interfaces to form a new PCI bus can be a useful configuration in redundant fault-tolerant systems. Two bridges A, B in FIG. 2 are connected by their secondary interfaces and masters (e.g. a processor, not shown) behind bridge A are able to address targets behind bridge B. Bridge A forwards a transaction or request (address) on the primary side through the transparency window to the bus on the primary side of bridge and bridge B forwards everything else back through its window. A master initiated transaction from behind Bridge B would work the same way only in reverse.

In more complex configurations, for instance, where three bridges are used to connect three buses, conflicts can arise when one bridge can accept transactions through two bridges. FIG. 3 demonstrates the conflict. There, bridge A and bridge C are assumed to be set up so that each transparency window is defined to encompass the other two local memory spaces. In that case, only one memory range is available for bridge B's window need to claim. Only one transparent region is available but in fact two separate spaces are needed. A transaction initiated on the primary side of Bridge B and destined for an address in the Bridge C memory region (out of the window) will be claimed by bridge C and successfully completed. But a transaction initiated behind bridge C and addressed to the local space, or primary side of bridge B, will fail when both bridge A and Bridge B both try to claim the transaction. The window arrangement for bridge B would preclude the conflict, if it were possible to subdivide upper and lower addresses as illustrated, which it is not. For this reason, the PCI standard calls the arrangement in FIG. 3 an “Unsupported Configuration”. So-called “non-transparent bridges”, which have a memory window definition on both sides of the bridge along with some address translation mechanisms, are available, but providing windows on both sides of the bridge, as they do, is complex and expensive.

There are three different types of PCI address ranges available; prefetchable, non-prefetchable and I/O. All three of these different types have a base register and limit register in the PCI Bridge configuration space. I/O and non-prefetchable (memory) accesses are volatile transactions that only touch the desired memory. Prefetchable memory, on the other hand, extends the requested access to read ahead a configurable number of words to a cache boundary, as an attempt to reduce future traffic on the secondary side of the bus. This improves performance by taking advantage of the locality of typical back-to-back accesses. It should be understood that this range has no equivalent form on the secondary side of the bus and only exists for a request from primary to secondary. This choice makes sense to keep data as close to the initiating master as possible and because the ability to prefetch and store on a remote bridge does not impede bus traffic. From these definitions, it can be seen that simply reversing the I/O, non-prefetchable (memory) and prefetchable ranges will not avoid the above-described conflict because the prefetchable region does not apply going from the secondary to primary thus this memory range can not be reversed.

### SUMMARY

According to the invention, a bridge has the logic for the transparency window reversed (“inverted sense”). By inverting the sense, the configuration master (e.g. M in FIG. 4) can command of a bridge what memory is needed on the local side and not what memory is to be seen on the secondary side. That is, memory accessible on the secondary side is implied, as opposed to being implied on the primary side in the prior art. As a result, secondary to secondary bridge connections are possible.

Other objects, benefits and features of the invention will apparent to one of ordinary skill in the art from the drawing and following description.

### BRIEF DESCRIPTION OF THE DRAWING

FIG. 1 is functional block diagram of single bridge that shows the transparency window among possible bridge transactions and presumes separate PCI buses on the primary and secondary sides and a single transparency window as shown.

FIG. 2 is a functional block diagram showing two bridges with connected secondary sides, each bridge presumed to have a PCI bridge on its primary side and have transparency windows as shown.

FIG. 3 demonstrates a theoretical conflict that can arise in the prior art using three or more bridges.

FIG. 4 is a block diagram that shows four PCI buses connected through bridges configured according to the invention.

FIG. 5 is a flow chart showing steps according to the invention operating the primary side of a bridge.

FIG. 6 is a flow chart showing steps according to the invention for operating the second side of a bridge.

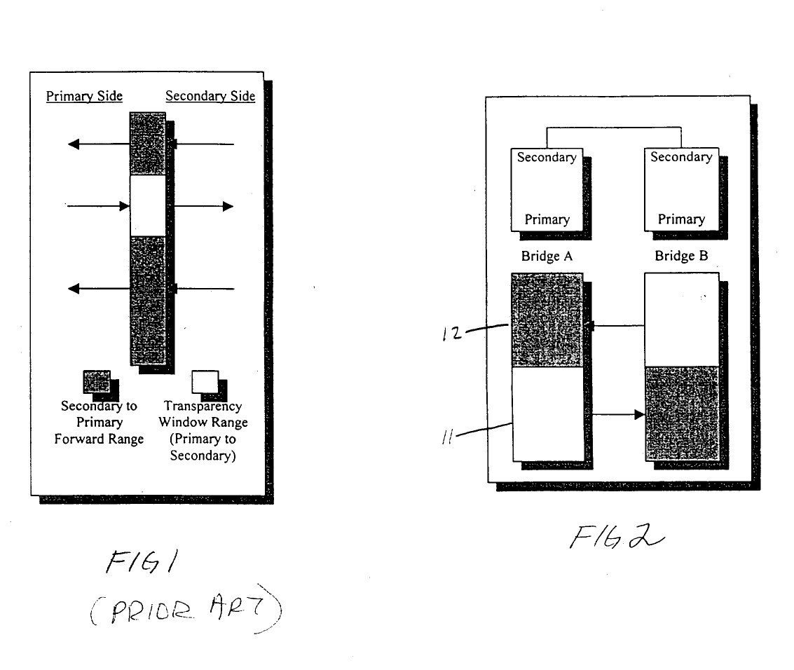

### DESCRIPTION

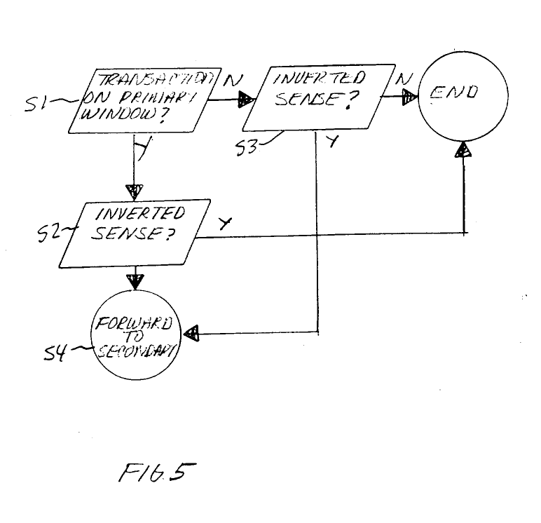

In FIG. 4, each of the masters M includes its own PCI bus 9, and PCI bridges 14 connect the masters. It should be appreciated that the previously described “unsupported configuration” arises in the connection of the secondaries on the bridges 14a and 14b. In contrast, the connection between the master 20 through the bridge 14c to the PCI bus 9a is supportable, being “primary to secondary”. The master 20 is the only controller that initially configures all of the bridge windows so that bidirectional communication and take place. In the case of bridge 14a, its sole function is to connect the master 18. The bridge 14c provides the connection to two targets T. Any target T may be a device such as a sensor or memory.

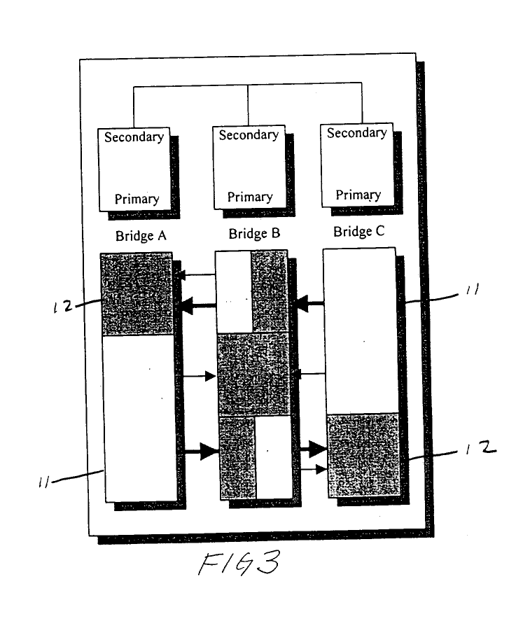

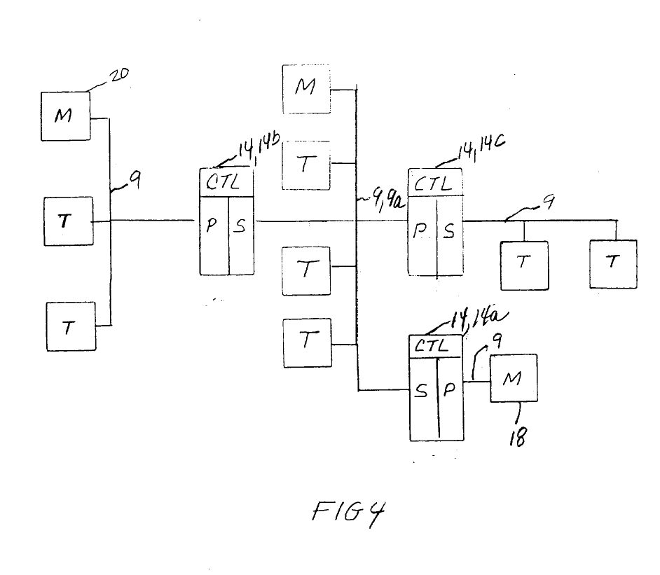

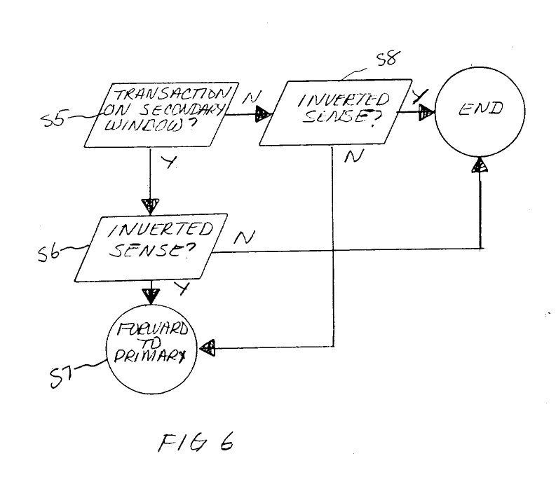

To remedy the conflict that arises from bridge 14a, controller CTL in each bridge is programmed to direct transactions between the primary P and secondary S sides through the transparency windows (numerals 11 in FIG. 2) by following the logic illustrated in FIGS. 5 and 6. As explained previously, the addresses through the window are initially determined by the controller 20.

Referring to FIG. 5, the first step S1 determines whether the transaction is on the bridge's primary or secondary side. Steps S2 and S3 refer to “inverted sense”, a term that means that the transaction address is the opposite of what it is following the supported PCI standard. By that standard, a transaction within the transparency window passes and any others cannot by default. An “inverted sense” produces the opposite result. A transaction on the primary window produces an affirmative answer to step S1, leading to step S2 which tests whether the address is inverted. If it is, the transaction is forwarded to the secondary window and thus to another bus, such as bus 9a. A negative answer at step S1 means that the transaction is on the secondary window, and an affirmative answer to the inverted sense test at S3 keeps the transaction on the secondary window or local. Nothing happens (End) if there a negative answer in step S3 or an affirmative answer had step S2. The process is only half completed. The test routine in FIG. 6 IS also run for any transaction to on either side of the bridge. Step S5 determines if the transaction is on the secondary window. If it is, an affirmative answer, and if the sense is found to be inverted, step S6 produces an affirmative result signaling the controller to forward the transaction to the primary at step S7. If the transaction is not on the secondary window, the answer at step S5 is negative. If the transaction is inverted, an affirmative answer to step S8, nothing changes. But if the test at step S8 is negative, the transaction is transmitted to the primary at step S7.

One skilled in the art may make modifications, in whole or in part, to a described embodiment of the invention and its various functions and components without departing from the true scope and spirit of the invention.

1. A bridge for connecting two buses, comprising:
a primary side connected to one bus;
a secondary window connected to a second bus;
a controller comprising means for defining a window for transferring transactions between said first and second buses from a plurality of possibility of transactions by selecting transactions on the second bus, assigning all other transactions on the primary side to the first bus, assigning said plurality of transactions on the secondary side to the secondary side and assigning said other transactions on said secondary side to said window for the bus on said primary side.

2. A system comprising:
a master controller on a first bus connected to a target;
a second master controller on second bus connected to a target;
a bridge having a primary side connected to the first bus and a secondary side connected to the second bus;
a master on a third bus;
a bridge having a primary side connected to the third bus and secondary connected to the secondary bus;
each bridge comprising a controller comprising means for performing non-conflicting transactions through a window between the primary and secondary sides with any target and any master.

3. The system described in claim 2, wherein each bridge comprises means for defining a window for transferring transactions between buses on the primary and second sides from a plurality of possibility of transactions by selecting transactions on the secondary side, assigning all other transactions on the primary side to the first bus, assigning said plurality of transactions on the secondary side to the secondary side and assigning said other transactions on said secondary side to said window for the bus on said primary side.
